(19) United States
(12) Patent Application Publication
(10) Pub. No.: US 2004/0260687 A1
(43) Pub. Date: Dec. 23, 2004

(54) Document retrieval apparatus that accentuates retrieval keyword based on feature index

(76) Inventor: Hiroko Mano, Tokyo (JP)

Correspondence Address: DICKSTEIN SHAPIRO MORIN & OSHINSKY LLP, 2101 L STREET NW, WASHINGTON, DC, 20037-1526, US

(21) Appl. No.: 10/828,308

(22) Filed: Apr. 21, 2004

(30) Foreign Application Priority Data
Apr. 22, 2003 (JP) 2003-116540

(51) Int. Cl. G06F 17/30

(52) U.S. Cl. 707/3

(57) ABSTRACT

A document retrieval apparatus is disclosed, including a query character string input unit that accepts an input of query character string including multiple retrieval keywords, a document select unit that selects documents that match the query character string from a document database, a retrieval result output unit that presents retrieval results of the selected documents to a user, and a document output unit that presents the contents of one of the selected documents designated by the user. A feature index that indicates the extent to which each retrieval keyword has contributed to the retrieval for documents is computed. The document output unit determines a manner in which the retrieval keyword is displayed in accordance with the feature index.

### BACKGROUND OF THE INVENTION

1. Field of the Invention

The present invention generally relates to a document retrieval apparatus, and more particularly, to a document retrieval apparatus that can retrieve documents matching a given query character string.

The present invention further relates to a method of retrieving a document matching a given query character string, a computer program that causes a computer to perform the method, and a computer readable recording medium storing the computer program.

2. Description of the Related Art

Recently, document databases that store a great amount of documents are widely used, and document search apparatuses that retrieve documents that match a user's requirements from the documents stored in the document databases are being improved.

Typically, a document search apparatus displays an input screen through which a user can input search keywords and other query character strings. The document search apparatus searches for one or more documents using the query character strings, and displays the list of documents matching the query character strings. Bibliographic information such as title, location, and date may be displayed too.

If a user selects one of the documents and clicks the link to the selected document, the document search apparatus displays the contents of the selected document. As a result, the user can retrieve one or more documents that the user needs to find.

When the user browses the contents of the selected document, the user looks for the search keyword as a clue to identify information that she requires. If there are only a few search keywords included in the document, the user may determine that the document is not one that she is looking for. In order to support such behavior of the user, the document search apparatus generally highlights the search keywords included in the selected document.

Japanese Laid-Open Patent Application No. 10-269233 discloses a document search apparatus that highlights the query character strings of different kinds (complete matching, synonym matching, and neighborhood matching, for example) in different manners (reversion, color, block, for example).

This conventional document search apparatus has the following problems.

Highlighting the query character strings of different kinds in different manners is premised on Boolean search in which only a YES/NO determination is made about whether a document matches the query character strings. However, in the case of “ranking search” in which a quantitative determination can be made about whether a document matches the query character strings, the method of highlighting the query character strings of different kinds in different manners is not beneficial enough to the user. It is important that the user knows the extent to which the document matches the query character strings. It is preferred for the document search apparatus to be able to display the amount of contribution made by each search keyword as a reference.

Highlighting the query character strings helps the user to overview the selected documents. The conventional method fails to help the user in the case in which the user wants to identify search keywords that are not suitable for the retrieval. For example, in the case in which the user knows that the search keyword is useless as a query character string, but she wants to read paragraphs including the search keyword, the conventional method does not work.

If there are a few documents including a search keyword, but the search keyword appears very frequently, the search keyword is effective as a query character string. However, if the search keyword is highlighted on the screen, the user may feel it difficult to see the screen. The conventional method still has the above problems.

It is preferred that the user can not only identify the search keyword, but also quickly refer to the paragraphs including the search keyword.

### SUMMARY OF THE INVENTION

Accordingly, it is a general object of the present invention to provide a novel and useful document search apparatus in which at least one of the above problems is eliminated.

Another and more specific object of the present invention is to provide a document search apparatus that determines the manner in which each search keyword is displayed in accordance with a feature index indicating the extent to which the search keyword contributes to the search, and displays the search keyword in the determined manner.

To achieve at least one of the above objects, a document search apparatus according to the present invention includes: a query character string input unit that accepts an input of a query character string including a plurality of search keywords; a document select unit that selects one or more documents that match the query character string from a document database; a search result output unit that presents search results of the selected documents to a user; and a document output unit that presents the contents of one of the selected documents designated by the user; wherein the document output unit determines the manner in which the search keywords are displayed in the presented one of the selected documents in accordance with a feature index indicating the extent to which the search keyword has contributed to the selection of the documents, and highlights the search keyword in the determined manner.

The feature index is computed so as to indicate the extent to which each search keyword has contributed to the retrieval of the documents. The document output unit determines the manner in which the search keyword is displayed in accordance with the feature index. Accordingly, it is easy to recognize not only that the search keyword is included and how frequently the search keyword appears in the document, but also the extent to which the search keyword has contributed to the search of documents.

Other objects, features, and advantages of the present invention will become more apparent from the following detailed description when read in conjunction with the accompanying drawings.

### BRIEF DESCRIPTION OF THE DRAWINGS

FIG. 1 is a block diagram showing the configuration of a document search apparatus according to an embodiment;

FIG. 2 is a network diagram showing a document search system including a server as a document search apparatus according to an embodiment;

FIG. 3 is a block diagram for explaining a document search apparatus according to an embodiment;

FIG. 4 is a block diagram for explaining a document search apparatus according to another embodiment;

FIG. 5 is a block diagram for explaining a document search apparatus according to yet another embodiment;

FIG. 6 is a flowchart for explaining the operation of the document search apparatus according to an embodiment;

FIG. 7 is an exemplary initial screen that is displayed by a query character string input unit according to an embodiment;

FIG. 8 is an exemplary screen that is displayed when “TO NATURAL SENTENCE INPUT SCREEN” is pressed;

FIG. 9 is an exemplary input screen that is displayed by the query character string input unit according to another embodiment;

FIG. 10 is an exemplary screen that is displayed by a search result output unit and a document output unit according to an embodiment;

FIG. 11 is a flowchart for explaining the operation of the document search apparatus according to another embodiment;

FIG. 12 is an exemplary input screen that is displayed by the query character string input unit according to another embodiment;

FIG. 13 is a flowchart for explaining the operation of the document search apparatus according to yet another embodiment;

FIG. 14 is an exemplary screen that is displayed by the search result output unit and the document output unit according to another embodiment;

FIG. 15 is an exemplary screen that is displayed by the search result output unit and the document output unit according to yet another embodiment; and

FIG. 16 is an exemplary screen for changing search keywords.

### DETAILED DESCRIPTION OF THE PREFERRED EMBODIMENTS

The preferred embodiments of the present invention are described in detail below.

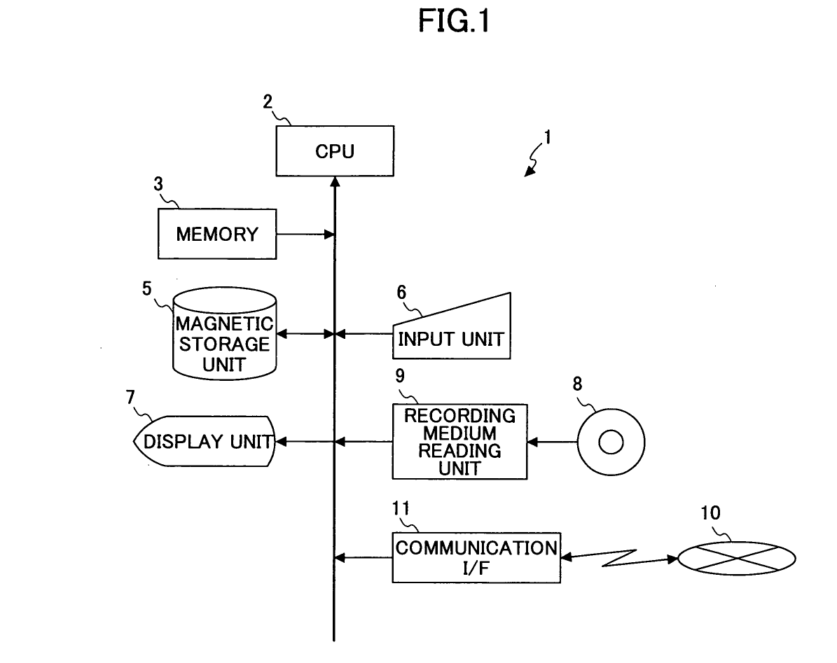

FIG. 1 is a block diagram showing the configuration of a document search apparatus according to an embodiment. The document search apparatus 1 includes a CPU 2, a memory 3, a magnetic storage unit 5, an input unit 6, a display unit 7, a recording medium reading unit 9, and a communication interface (I/F) 11, being connected to one another via a bus 4.

The CPU 2 controls other components connected thereto via the bus 4. The memory 3 may include a read only memory (ROM) and a random access memory (RAM). The magnetic storage unit 5 may be a hard disk drive (HDD), for example. The input unit 6 may be a mouse and a keyboard, for example. The display unit 7 may be made up by a liquid crystal display (LCD) or a cathode ray tube (CRT), for example.

The recording medium reading unit 9 reads information stored in a recording medium 8 set therein. The recording medium 8 may be an optical disk such as a compact disk (CD-ROM, CD-RW, and CD-R, for example) and a digital video disk (DVD, DVD-RAM, for example), a magneto-optical disk, a flexible disk, and a memory card, for example. The communication interface unit 11 connects the document search apparatus 1 to a network 10.

As described above, the document search apparatus 1 is basically a computer such as a personal computer. A computer program (document search program) that causes the computer to function as the document search apparatus 1 may be stored in the magnetic storage unit 5. The document search program may be read by the recording medium reading unit 9 from the recoding medium 8 or may be downloaded from the network 10 via the communication interface 11, and be installed in the magnetic storage unit 5. The document search program may be executable on a specific operating system (OS). The document search program may be included in an application program as a module.

As described above, the present invention includes a document search program and a recording medium storing the document search program as aspects thereof, as well as a document search apparatus and a method of retrieving a document.

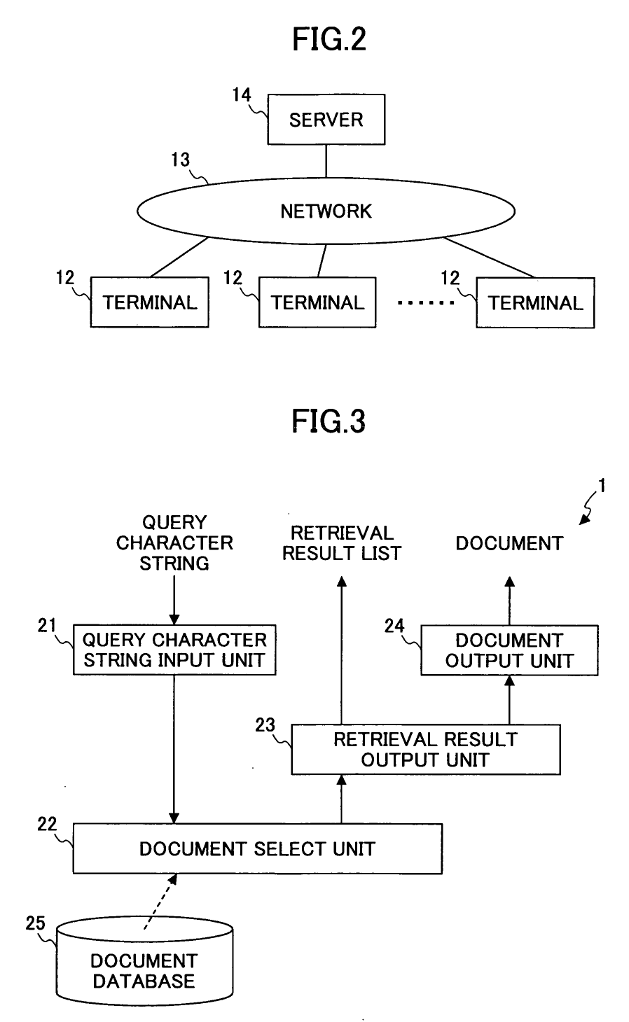

FIG. 2 is a network diagram showing the configuration of a document search system according to an embodiment. The document search system shown in FIG. 2 includes terminals 12 and a server computer 14 connected via a network 13. The server computer 14 functions as the document search apparatus 1. The server computer 14 is accessible and operable by any one of the terminals 12.

The terminal 12 may be an information processing apparatus such as a personal computer (PC) a mobile information terminal (PDA, for example), and a mobile phone. The network 13 may be wireless or on wire. For example, the network 13 may be a local area network (LAN), a wide area network (WAN), the Internet, an analog public switched telephone network, an integrated services digital network, a personal handy-phone system network, a cellular phone network, and a satellite communication network.

The operation of the document search apparatus 1 according to an embodiment is described below.

FIG. 3 is a functional block diagram for explaining the operation of the document search apparatus 1 according to an embodiment.

The document search apparatus 1 includes a query character string input unit 21, a document select unit 22, a search result output unit 23, a document output unit 24, and a document database 25. The document database 25 stores many electronic documents organized as a database. The query character string input unit 21 accepts the input of a query character string designated by a user. The document select unit 22 selects one or more documents that match the designated query character string from the document database 25. The search result output unit 23 outputs the selected documents as a list to the display unit 7 shown in FIG. 1, for example. In response to designation of one of the selected documents by the user, the document output unit 24 outputs the contents of the designated document to the display unit 7 shown in FIG. 1.

When retrieving a document matching the query character string in the document database 25, if a Boolean search is requested, the document select unit 22 looks for documents including the search keyword. If a ranking search is requested, the document select unit 22 ranks the documents in the document database 25 in accordance with frequency at which the search keyword appears in the documents.

The document database 25 is stored in the magnetic storage apparatus 5 shown in FIG. 1. The query character string input unit 21, the document select unit 22, the search result output unit 23, the document output unit 24, and the document database 25 are realized by the CPU 2 that executes the document search program.

In the above exemplary embodiment, the document database 25 is provided in the document search apparatus 1. However, according to another embodiment, the document database 25 may be provided separately from the document search apparatus 1. In such a case, the document search apparatus 1 may access the document database 25 via a network, for example.

A feature index is assigned to each search keyword to indicated the extent to which the search keyword has contributed to the retrieval of documents. The document output unit 24 determines the manner in which the search keyword is to be displayed in accordance with the feature index, and displays the search keywords in the respective determined manners.

The feature index of a search keyword may be, but is not limited to, the number of documents that includes the search keyword, for example. The feature index is computed by the search result output unit 23 by counting the documents that include the search keyword.

The operation of the document output unit 24 is described in further detail below. The document output unit 24 displays the highlighting of the search keywords that appear in the document designated by the user so as to make the search keywords noticeable. The document output unit 24 determines the manner in which the search keyword is displayed. For example, the search keyword is highlighted by changing font color thereof, making fonts bold, making fonts italic, underlining, making font size big, and changing fonts.

The extent to which the search keyword is highlighted is differentiated in accordance with the extent to which the search keyword has contributed to the search of documents. In the case of the ranking search, the search keyword that appears only in a small number of documents is generally used for ranking the documents in the document database. Accordingly, the search keyword that appears in a predetermined number of documents or less, which has greatly contributed to the selection of the documents, may be displayed using dark red fonts, for example, and the search keyword that appears in more than the predetermined number of documents may be displayed using light red fonts, for example.

According to the above arrangements, the user can recognize not only whether the search keyword is included in the document and how frequently the search keyword appears in the document, but also how much the search keyword has contributed to the retrieval of the documents.

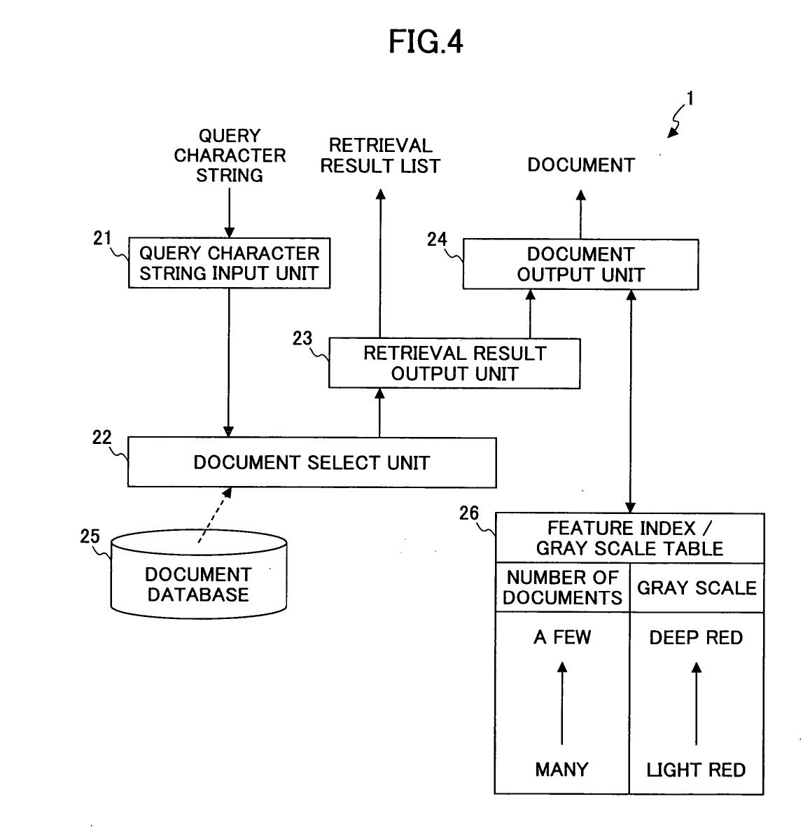

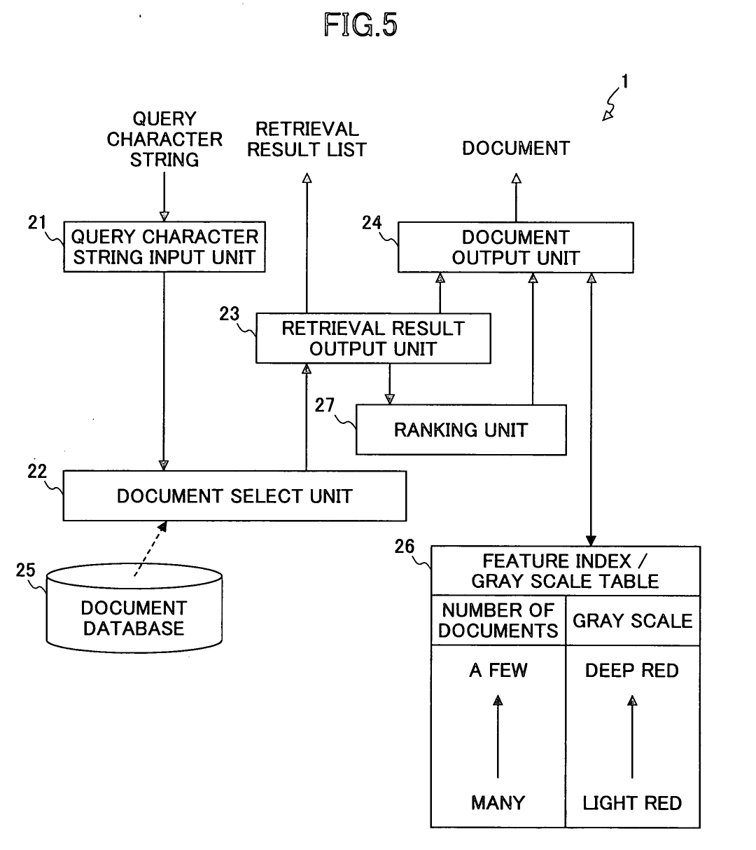

FIG. 4 is a functional block diagram for explaining the operation of the document search apparatus 1 according to another embodiment.

The document search apparatus 1 includes a query character string input unit 21, a document select unit 22, a search result output unit 23, a document output unit 24, and a document database 25, and further includes a feature index/gray scale table 26 in which the corresponding relation of the feature index to a gray scale (shades) of a color (red, for example) is registered.

In an exemplary embodiment, the feature index is correlated to the gray scale of a color. However, according to another embodiment, the feature index may be correlated to a set of colors (red, yellow, and green, for example), and a feature index/color table (not shown) may be provided to the document search apparatus 1. According to yet another embodiment, the feature index may be correlated to the type face of a character, and a feature index/type face table (not shown) may be provided to the document search apparatus 1. According to yet another embodiment, the feature index may be correlated to any combination of the gray scale, the color set, or the type face, and more than one of the above tables may be provided to the document search apparatus 1.

The document search apparatus 1 has the feature index/gray scale table 26. The document output unit 24 determines the gray scale in which the search keyword is displayed with reference to the feature index/gray scale table 26, and displays highlighting the search keyword using shades of the determined gray scale so as to differentiate the search keyword from other words.

In the case where the feature index is the number of documents including the search keyword, the more documents a search keyword is included in, the lighter gray scale the search keyword is correlated to (the less the search keyword has contributed to the search of documents).

According to another embodiment, if the document search apparatus 1 is provided with the feature index/color table (not shown), the document output unit 24 determines the color corresponding to the feature index of the search keyword with reference to the feature index/color table, and displays the highlighting of the search keyword using the determined color so as to differentiate the search keyword from other words included in the document. In such a case, the font color with which the search keyword is displayed is determined based on the contribution of the search keyword to the retrieval of the documents. For example, the search keywords displayed with red font, yellow font, green font, . . . , have contributed to the retrieval of the documents in that order.

According to yet another embodiment, if the document search apparatus 1 is provided with the feature index/type face table (not shown), the document output unit 24 determines the type face corresponding to the feature index of the search keyword with reference to the feature index/type face table, and displays the highlighting of the search keyword using the determined type face so as to differentiate the search keyword from other words included in the document. In such a case, the type face with which the search keyword is displayed is determined based on the contribution of the search keyword to the retrieval of the documents. For example, the type face includes the style of characters such as font, size, bold, italic, and underline.

FIG. 5 is a functional block diagram for explaining the operation of the document search apparatus 1 according to yet another embodiment.

The document search apparatus 1 includes a query character string input unit 21, a document select unit 22, a search result output unit 23, a document output unit 24, a document database 25, and a feature index/gray scale table 26, and further includes a ranking unit 27.

The ranking unit 27 ranks the search keywords included in the document based on the feature index of the search keyword. When the document output unit 24 displays the highlighting of the search keywords in the document, the document output unit 24 may indicate the result of ranking by the ranking unit 27 to be displayed in the document. The search keywords may be ranked based on the number of documents including the search keywords (the smaller the number of documents including the keyword is, the more the keyword is considered to have contributed to the retrieval of documents), and the result of ranking may be displayed as 1, 2, 3, . . . , or A, B, C, . . . , for example.

According to the above arrangements, the user can recognize not only whether the search keyword is included in the document and how frequently the search keyword appears in the document, but also how much the search keyword has contributed to the retrieval of the documents. Additionally, since the search keyword is ranked based on its feature index, the user can recognize which search keyword has contributed to the retrieval of the documents.

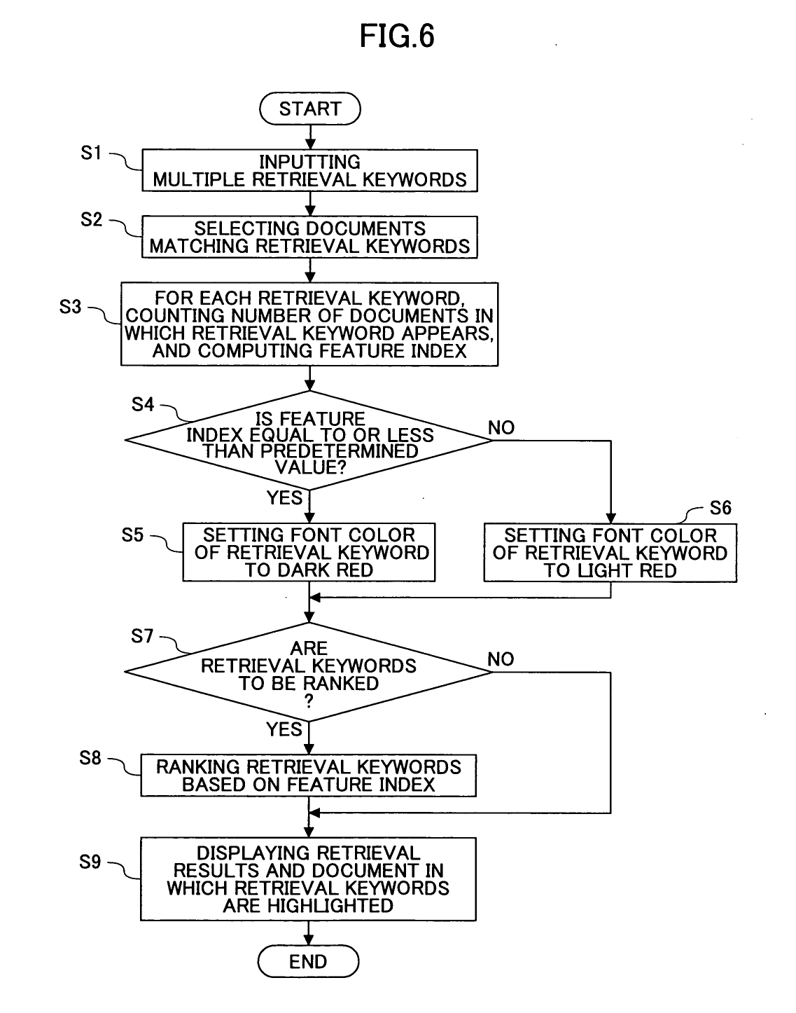

FIG. 6 is a flowchart for explaining a method of retrieving a document according to an embodiment. The method of retrieving a document is explained as the operation of the document search apparatus 1 shown in FIG. 5 except for the feature index/gray scale table 26. As a result, the document search apparatus 1 determines the manner in which the search keyword is displayed based on a determination of whether the feature index is equal to or less than a predetermined value. However, the method of retrieving a document is not limited to the operation of the document search apparatus 1. The document search apparatus 1 may include the feature index/gray scale table 26.

The query character string input unit 21 receives an input of multiple search keywords (step S1). The document select unit 22 selects documents that match the input search keywords from the document database 25 (step S2). The search result output unit 23 counts, for each search keyword, the number of documents including the search keyword, and computes a feature index (step S3).

The document output unit 24 determines, one by one, whether the feature index of each search keyword is equal to or less than a predetermined value (step S4). If the feature index of the search keyword is equal to or less than the predetermined value (YES in step S4), the document output unit 24 sets the font color of the search keyword to dark red (step S5). If the feature index of the search keyword is greater than the predetermined value (NO in step S4), the document output unit 24 sets the font color of the search keyword to light red (step S6).

The document output unit 24 determines whether the search keywords are to be ranked based on the feature indexes (step S7). If the search keywords are to be ranked (YES in step S7), the ranking unit 27 ranks the search keywords in accordance with the feature indexes (step S8). If the search keywords are not to be ranked (NO in step S7), the process proceeds to step S9.

In step S9, the document output unit 24 displays the search result from the search result output unit 23, and the contents of a document (the document ranked on the top, for example) in which the search keywords are highlighted using the font color set in steps S5 and S6 (step S9).

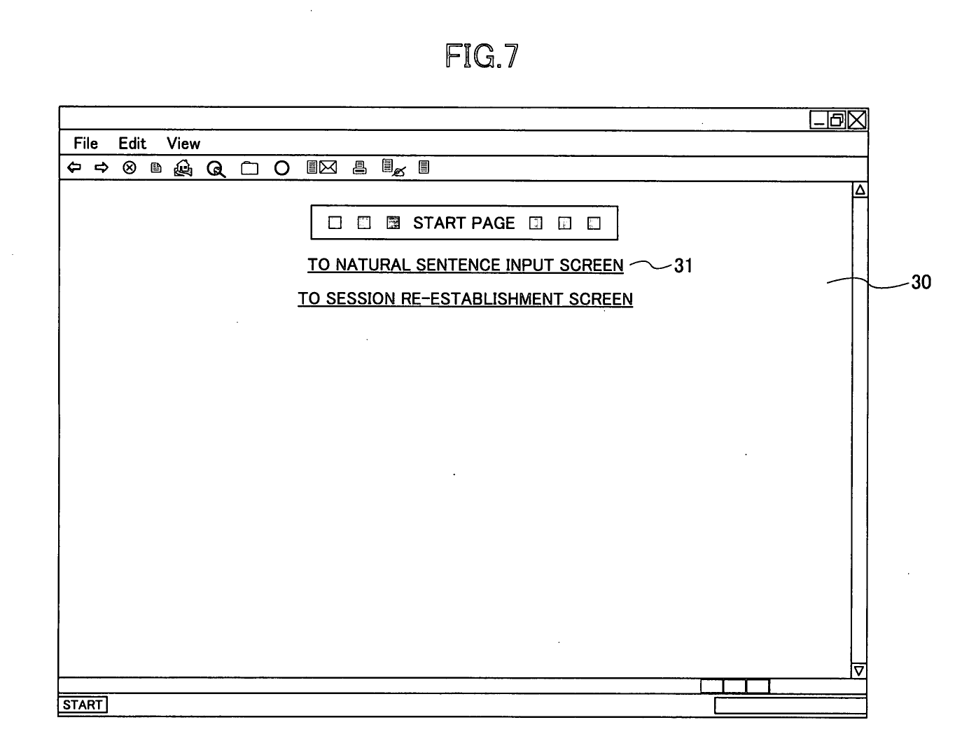

FIG. 7 is an exemplary start screen that is displayed on the display unit 7 by the query character string input unit 21. A start screen 30 is provided with a link “TO NATURAL SENTENCE INPUT SCREEN” 31 in which the query character string can be input. The user clicks the link “TO NATURAL SENTENCE INPUT SCREEN” 31, and moves to a natural sentence input screen.

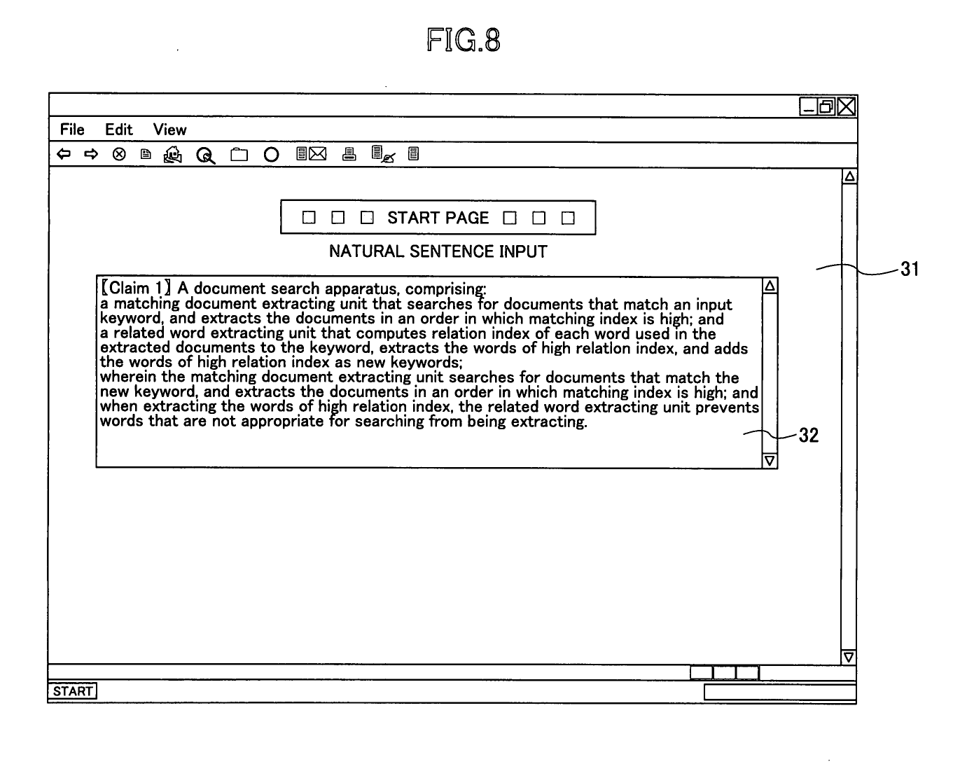

FIG. 8 is an exemplary natural sentence input screen according to an embodiment that is displayed in response to clicking the link “TO NATURAL SENTENCE INPUT SCREEN” 31. When the user inputs a sentence as a query character string using the input unit 6, for example, the input sentence is displayed in the natural sentence input box 32.

If the user wants to retrieve patents and patent laid-open applications, for example, the user inputs a claim or an abstract that describes a technique that the user is looking for. Search keywords are extracted from the input sentences in accordance with a predetermined condition.

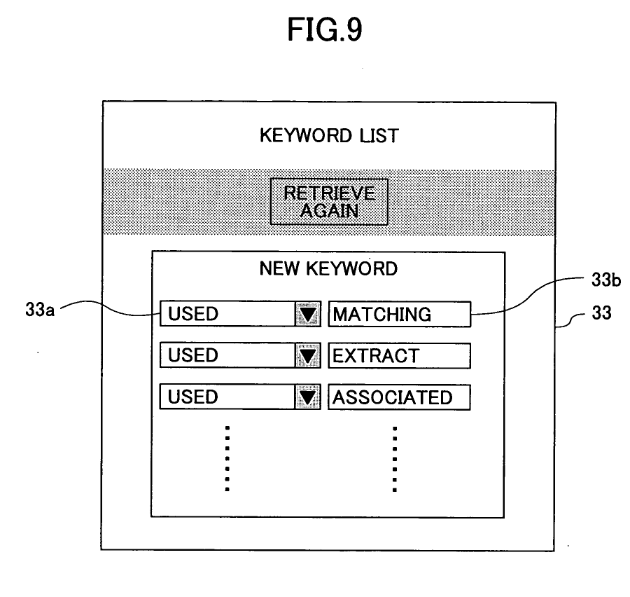

FIG. 9 is an exemplary input screen that is displayed on the display unit 7 by the query character string input unit 21 according to another embodiment. A keyword list input screen 33 includes multiple selection boxes 33a and corresponding input boxes 33b. The user can input any search keywords in the input boxes 33b. The default selection of the selection box 33a is “UNUSED”. If the selection box 33a is set at “USED” as shown in FIG. 9, the word input in the corresponding input box 33b is used as a search keyword. If the selection box 33a is set at “HIGHLIGHT” (described below), the word input in the corresponding input box 33b is not used for searching, but is highlighted.

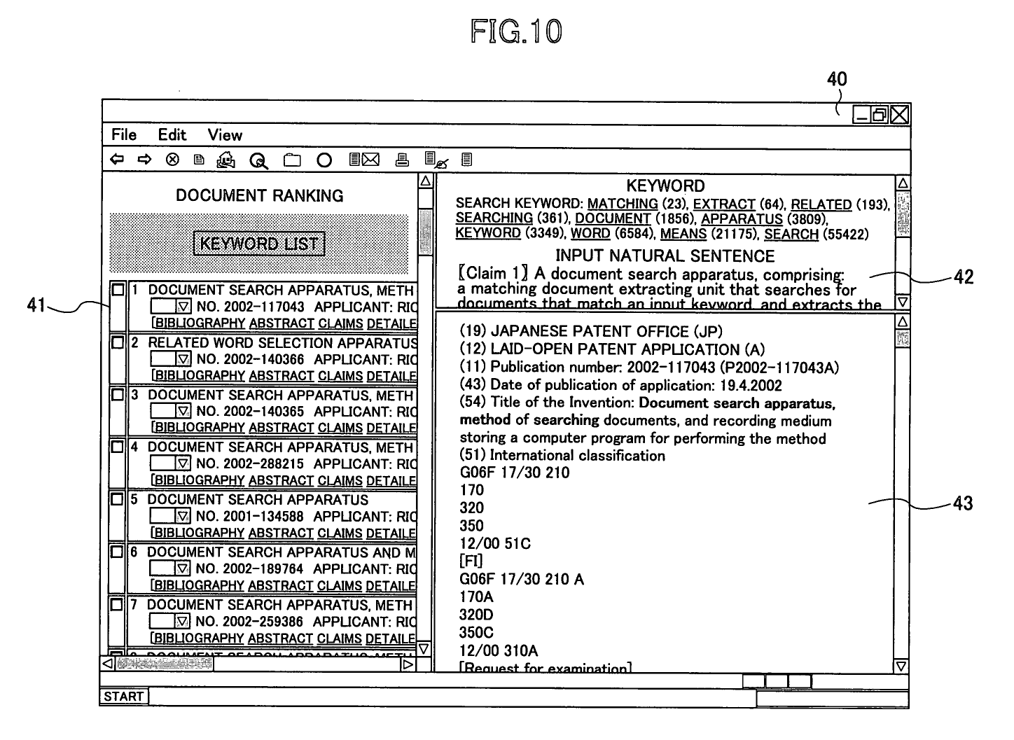

FIG. 10 is an exemplary search result display screen that is displayed by the search result output unit 23 and the document output unit 24 according to an embodiment. A search result display screen 40 includes the following: a document ranking frame 41 in which the result of the search is displayed, a search keywords frame 42 in which the search keywords used for the search are displayed, and a document frame 43 in which the contents of a document are displayed. The document that is ranked on the top in the document ranking frame 41, for example, is displayed in the document frame 43. If the user selects another document in the document ranking frame 41, the other document is displayed in the document frame 43.

Among other words shown in the document frame 43, the search keywords are highlighted. If the search keywords are highlighted in the document frame 43 by changing font colors thereof, the same keywords shown in the search keyword frame 42 are displayed using the same font colors, respectively. The numerals in parenthesis following each search keyword in the search keyword frame 42 represent the number of documents in which the search keyword appears, that is, the feature index. For example, a search keyword “matching” appears in 23 documents, which is regarded as the most contributing search keyword. The search keywords from “matching” to “search” are arranged in the order of the degree of contribution in the search keyword frame 42.

The exemplary embodiment above describes the manner (color and type face, for example) in which the search keyword is displayed in accordance with the feature index (the number of documents in which the search keyword appears, for example) of the search keyword, and the search keyword is highlighted in that manner. Accordingly, the user can easily determine whether the document contains information that she desires.

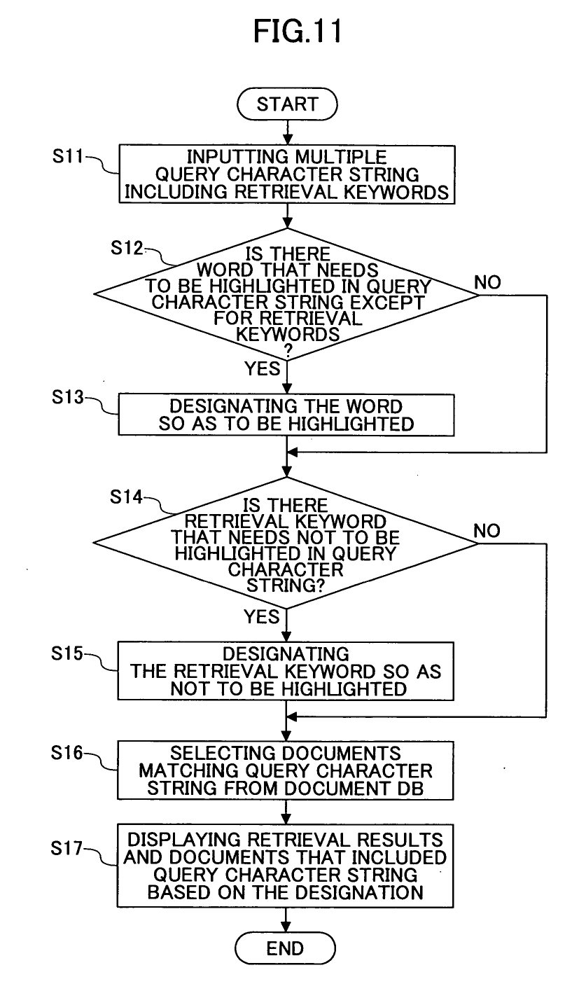

FIG. 11 is a flowchart for explaining a method of retrieving a document according to another embodiment. In the case of the method shown in FIG. 11, words other than the search keywords may be highlighted, and some of the search keywords may not be highlighted. The method is described as the operation of the document search apparatus 1 shown in FIG. 1 and FIG. 3.

The query character string input unit 21 receives an input of query character string including multiple search keywords (step S11). The query character string input unit 21 determines whether there is a word in the query character string other than the search keywords that is to be highlighted (step S12). If there is a word to be highlighted (YES in step S12), the word is identified as a word to be highlighted (step S13). If there is no word to be highlighted (NO in step S12), the process proceeds to step S14.

A determination is made of whether there is a search keyword that is not to be highlighted in the query character string input in step S11 (step S14). If there is a search keyword that is not to be highlighted (YES in step S14), the search keyword is identified as a word not to be highlighted (step S15) If there is no search keyword that is to be highlighted (NO in step S14), the process proceeds to step S16.

In step S16, the document select unit 22 selects documents stored in the document database 25 that match the query character string. The document output unit 24 displays the contents of a designated document highlighting the words identified as words to be highlighted in step S13 and the search keywords except for those identified as words not to be highlighted in step S15 (step S17).

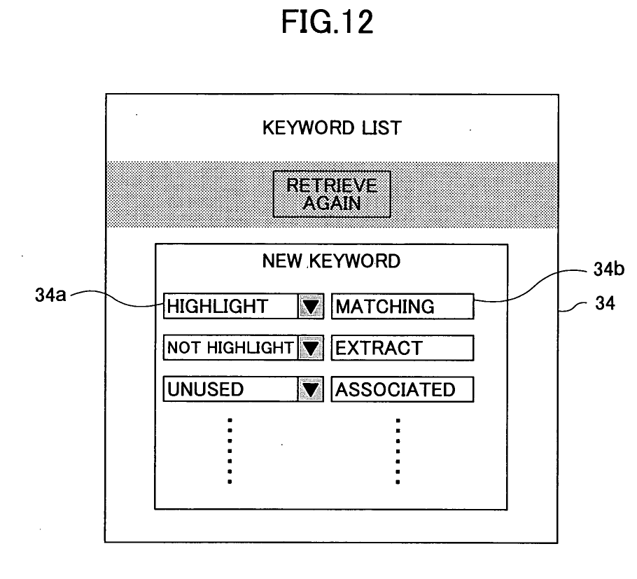

FIG. 12 is an exemplary input screen according to another embodiment displayed on the display unit 7 by the query character string input unit 21. A search keyword list input screen 34 includes multiple selection boxes 34a (default selection is “UNUSED”) and corresponding input boxes 34b in which the user can input any word as a search keyword. If the selection box 34a is set at “UESD”, the word input in the corresponding input box 34b is recognized as a search keyword. If the selection box 34a is set at “HIGHLIGHTED”, the word input in the corresponding input box 34b is not used as a search keyword, but is highlighted.

As described above, the query character string input unit 21 can accept not only an input of the search keywords, but also an input of words other than the search keywords that are to be highlighted. The query character string input unit 21 also can accept an input of the search keywords that are not to be highlighted. The document output unit 24 displays the contents of the document in accordance with the input.

The user may prefer highlighting a word without using it as a search keyword in a case in which the word does not work efficiently as a search keyword, but the word, if highlighted in the document, may help the user to understand the contents of the document. For example, in the case where the user searches for patents, if a word “laid-open application” is highlighted, the user easily knows the patent laid-open applications referred to in the document. On the other hand, if a search keyword is expected to appear frequently in the document, highlighting the search keyword makes the document even more difficult to read. If the search keyword is not highlighted, the user may feel it is easy to browse the document.

The exemplary embodiment is described above in which the user can designate one or more words other than the search keywords so as to highlight the words on the screen in which the contents of the document are displayed. The user can browse the document in which the designated words and the search keywords are appropriately highlighted. Additionally, the user can designate one or more keywords not to be highlighted in the screen. The user can browse the document in which the designated search keywords are not highlighted appropriately.

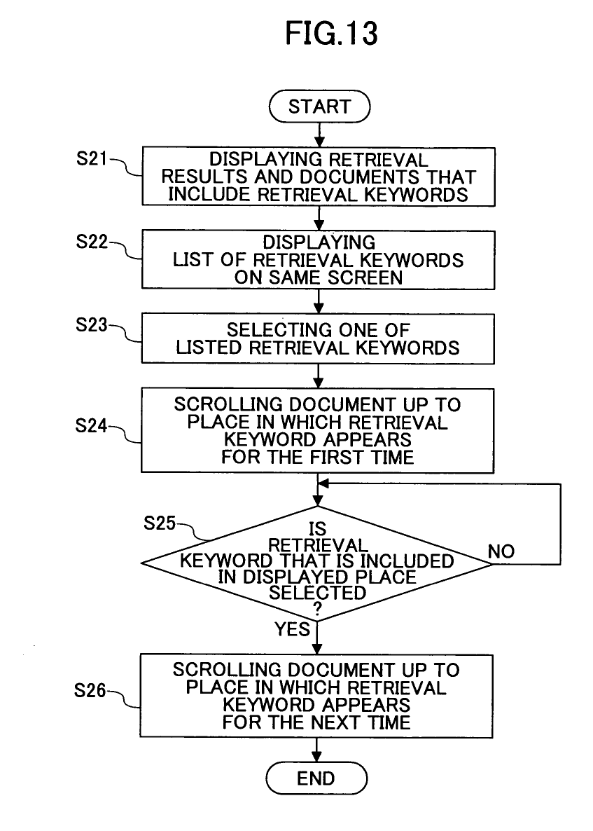

FIG. 13 is a flowchart for explaining a method of retrieving a document according to yet another embodiment. According to the present embodiment, after the search is performed, the search keywords are displayed. When the user selects one of the displayed search keywords, the document is scrolled up to a place where the selected one of the search keywords appears for the first time. If the search keyword is displayed in the place, the document is scrolled up to another place where the selected one of the search keywords appears for the second time. The method is explained as the operation of the document search apparatus 1, however, the method is not limited thereto.

The document output unit 24 displays the contents of the document including the search keywords with the search result obtained from the search result output unit 23 (step S21). The query character string input unit 21 or the search result output unit 23 displays the list of the search keywords that are used as the query character string in the same screen (step S22). One of the search keywords is selected in the list (step S23). The document output unit 24 scrolls the document up to a place where the selected search keyword appears for the first time (step S24). The document output unit determines whether the search keyword in the document has been selected (step S25). If the search keyword has been selected (YES in step S25), the document output unit 24 scrolls the document up to another place where the search keyword appears for the second time (step S26). If the search keyword has not been selected in step S25 (NO in step S25), the process waits until the search keyword is selected (waiting state). According to the above arrangements, the user can refer to the place where the search keyword appears in the document.

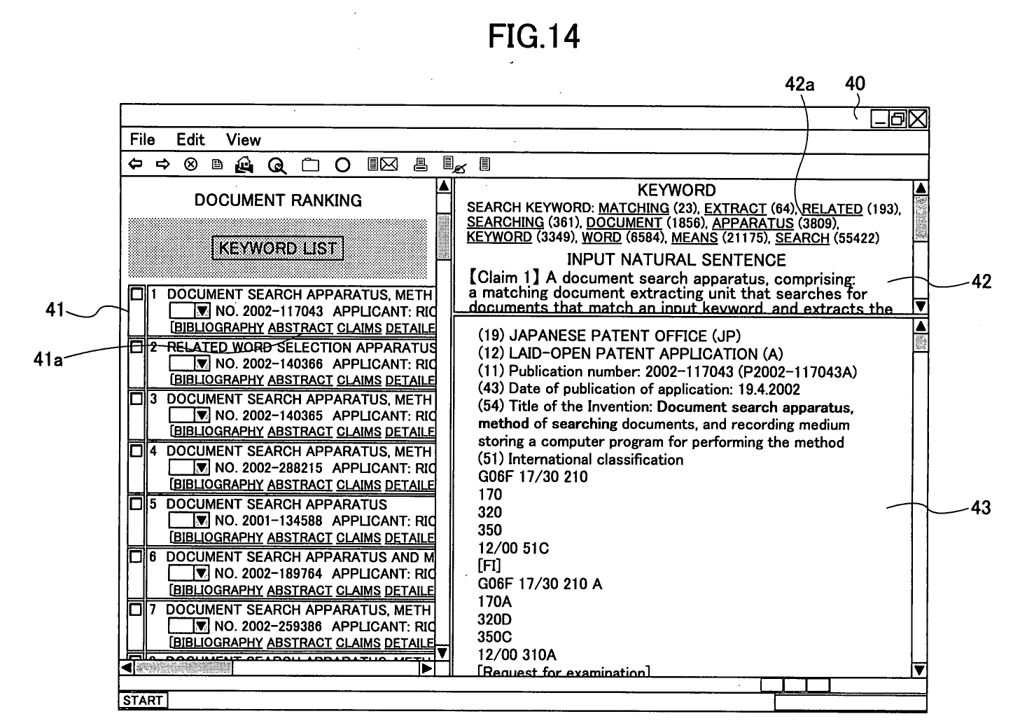

FIG. 14 is an exemplary search result display screen 40 according to an embodiment displayed by the search result output unit 23 and the document output unit 24. Each document ranked in the document ranking 41 is provided with links 41a such as “BIBLIOGRAPHY”, “ABSTRACT”, “CLAIMS”, . . . . When the link 41a is clicked, the document output unit 24 scrolls the document (document 43 in this case) to a corresponding place, and displays the corresponding place. Each search keyword 42 is provided with a link 42a. When the link 42a is clicked, the document output unit 24 scrolls the document 43 to a place where the search keyword appears for the first time, and displays the place.

The document output unit 24 may display position information indicating which part of the document is displayed. For example, in the case of laid-open patent applications, a paragraph number or a title of a section such as “CLAIMS” and “RELATED ART” may be displayed. In the case of general documents, a chapter number and a section number may be displayed. According to the above arrangements, the user can easily know which part of the document is displayed.

According to the present embodiment, when the query character string or the search keyword shown in the search result is clicked, the document is scrolled and a part of the document in which the search keyword appears first is displayed. Accordingly, the user can refer to the part of the document quickly. When the search keyword that appears in the displayed part of the display is clicked, the document is scrolled again, and another part of the document where the search keyword appears next is displayed. The user can refer to the other part of the document quickly.

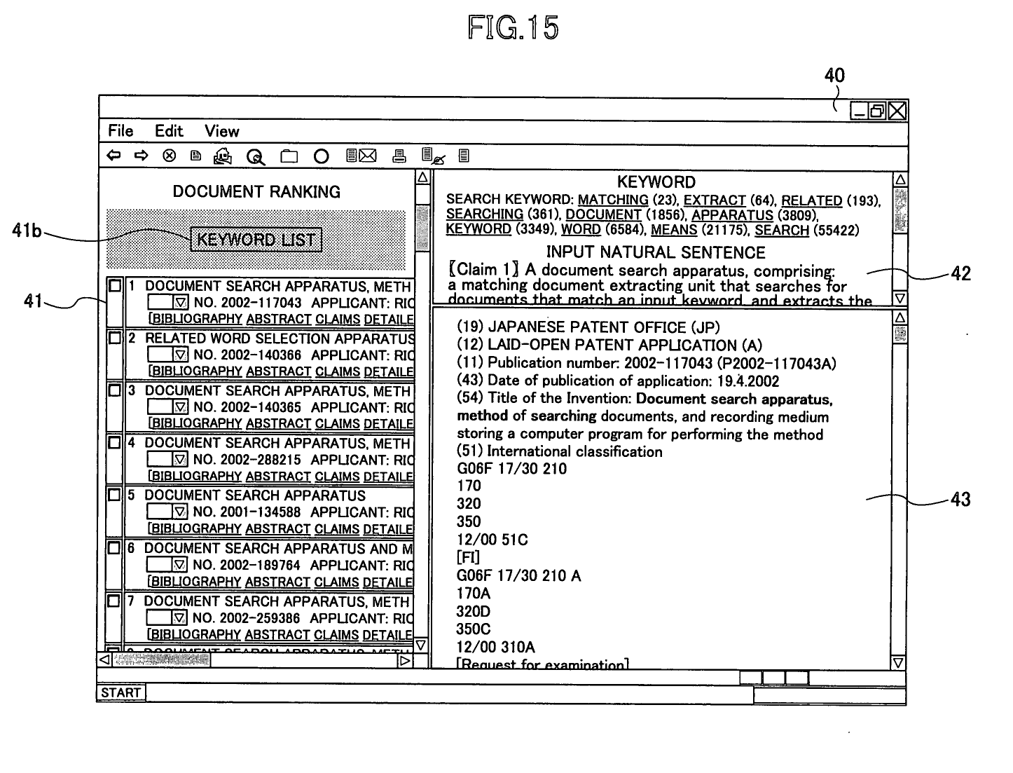

FIG. 15 is an exemplary search result display screen 40 according to another embodiment displayed by the search result output unit 23 and the document output unit 24. The user watches the search result which is the document ranking 41. If the search result is not what the user is expecting, the user can modify the search keyword and search again. The search keywords 42 are arranged in the order of the number of documents in which each search keyword 42 appears. The user can determine whether any search keyword, even if it hits only a small number of documents, prevents the search result from becoming what the user has been expecting. If there is such a search keyword, the user clicks a “KEYWORD LIST” 41b in the screen, and can change the search keywords.

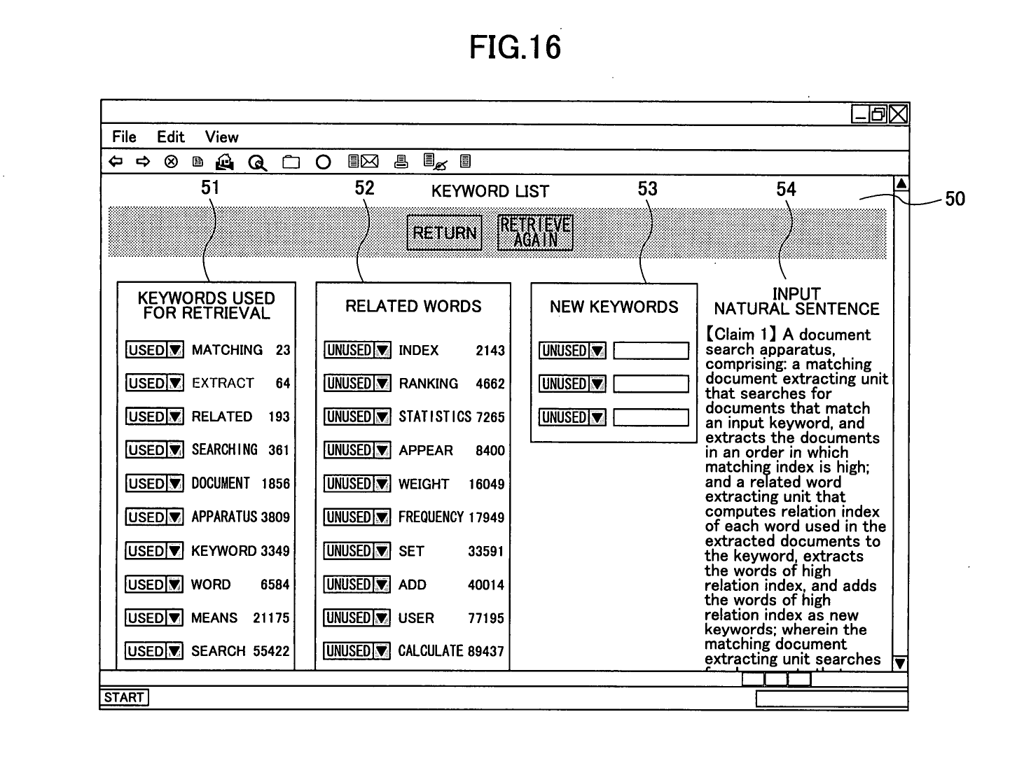

FIG. 16 is an exemplary keyword list screen according to an embodiment. The keyword list screen 50 includes the search keywords 51, related words 52, input boxes 53 for inputting new search keywords, and the input natural sentence 54. The search keywords 51 have been extracted from the input natural sentence 54. The keyword list screen 50 is displayed in response to clicking the “KEYWORD LIST” 41b (see FIG. 15). Referring to the keyword list of screen 50, the user can change the search keywords, and make the search again. The manner in which the search keywords are highlighted on the screen in the previous search is stored in the memory 3, for example. Accordingly, even if the search keywords are changed, the search keywords can be highlighted in the same manner.

The document search apparatus according to the present invention, which searches for documents using multiple search keywords, can display the search keywords included in the document in a manner (color and type face, for example) determined in accordance with the extent to which the search keywords have contributed to the retrieval of documents. The user can easily determine whether the searched documents include information that the user is looking for, and if included, where in the searched documents the information is located.

The preferred embodiments of the present invention are described above. The present invention is not limited to these embodiments, but variations and modifications may be made without departing from the scope of the present invention.

This patent application is based on Japanese Priority Patent Application No. 2003-116540 filed on Apr. 22, 2003, the entire contents of which are hereby incorporated by reference.

What is claimed is:

1. A document retrieval apparatus, comprising:
a query character string input unit that accepts an input of a query character string including a plurality of retrieval keywords;
a document select unit that selects one or more documents that match the query character string from a document database;
a retrieval result output unit that presents retrieval results of the selected documents to a user; and
a document output unit that presents the contents of one of the selected documents designated by the user;
wherein
the document output unit determines a manner in which the retrieval keywords are displayed in the presented one of the selected documents in accordance with a feature index indicating an extent to which each of the retrieval keywords has contributed to the selection of the documents, and highlights the retrieval keywords in the determined manner.

2. The document retrieval apparatus as claimed in claim 1,
wherein
the feature index corresponding to one of the retrieval keywords indicates the number of the selected documents including one of the retrieval keywords.

3. The document retrieval apparatus as claimed in claim 1, further comprising:
a feature index/color table in which a corresponding relation of the feature index to a color is registered;
wherein
the document output unit determines the color corresponding to the feature index of each retrieval keyword with reference to the feature index/color table, and displays the retrieval keyword using the determined color in a different manner from a manner in which other words are displayed.

4. The document retrieval apparatus as claimed in claim 1, further comprising:
a feature index/gray scale table in which a corresponding relation of the feature index to a gray scale of a color is registered;
wherein
the document output unit determines the gray scale of the color corresponding to each feature index of the retrieval keyword with reference to the feature index/gray scale table, and displays the retrieval keyword using the determined gray scale of the color in a different manner from a manner in which other words are displayed.

5. The document retrieval apparatus as claimed in claim 1, further comprising:
a feature index/type face table in which a corresponding relation of the feature index to a type face is registered;
wherein
the document output unit determines the type face corresponding to the feature index of each retrieval keyword with reference to the feature index/type face table, and displays the retrieval keyword using the determined type face in a different manner from a manner in which other words are displayed.

6. The document retrieval apparatus as claimed in claim 5,
wherein
the type face includes at least one of font, size, and style of a character.

7. The document retrieval apparatus as claimed in claim 1, further comprising:
a ranking unit that ranks the retrieval keywords included in the selected documents in accordance with a feature index indicating an extent to which each retrieval keyword has contributed to the selection of the selected documents;
wherein
the document output unit, when highlighting the retrieval keywords in the determined manner, displays the result of the ranking with the contents of one of the selected documents.

8. A document retrieval apparatus, comprising:
a query character string input unit that accepts an input of a query character string including a plurality of retrieval keywords;
a document select unit that selects one or more documents that match the query character string from a document database;
a retrieval result output unit that presents retrieval results of the selected documents to a user; and
a document output unit that presents the contents of one of the selected documents designated by the user;
wherein
the query character string input unit can accept an input of a word other than the retrieval keywords that is to be highlighted by the document output unit in the presented one of the selected documents.

9. The document retrieval apparatus as claimed in claim 8,
wherein
the query character string input unit accepts a designation of a retrieval keyword that is not to be highlighted in the designated one of the selected documents.

10. A document retrieval apparatus, comprising:
a query character string input unit that accepts an input of a query character string including a plurality of retrieval keywords;
a document select unit that selects one or more documents that match the query character string from a document database;
a retrieval result output unit that presents retrieval results of the selected documents to a user; and
a document output unit that presents the contents of one of the selected documents designated by the user;
wherein
one of the query character string input unit and the retrieval result output unit displays a list of the retrieval keywords used for the retrieval; and
when one of the retrieval keywords in the list is selected, the document output unit scrolls the presented one of the selected documents up to a place where the selected one of the retrieval keywords is first displayed.

11. The document retrieval apparatus as claimed in claim 10,
wherein
when any one of the retrieval keywords included in the presented one of the selected documents is selected, the document output unit scrolls to a next place where the selected one of the retrieval keywords appears and displays the next place.

12. The document retrieval apparatus as claimed in claim 10,
wherein
the document output unit can display position information that indicates a position of the selected one of the retrieval keywords in the presented one of the selected documents.

13. A method of retrieving documents, comprising the steps of:
accepting an input of a query character string including a plurality of retrieval keywords;
selecting one or more documents that match the query character string from a document database;
presenting retrieval results of the selected documents to a user; and
presenting the contents of one of the selected documents designated by the user;
wherein
a manner in which the retrieval keywords are displayed in the presented one of the selected documents is determined in accordance with a feature index indicating an extent to which each of the retrieval keywords has contributed to the selection of the documents, and the retrieval keywords are highlighted in the determined manner.

14. The method as claimed in claim 13,
wherein
the feature index corresponding to a retrieval keyword indicates a number of the selected documents including the retrieval keyword.

15. The method as claimed in claim 13,
wherein
a color corresponding to the feature index of each retrieval keyword is determined with reference to a feature index/color table in which a corresponding relation of the feature index to the color is registered, and the retrieval keyword is displayed using the determined color in a different manner from a manner in which other words are displayed.

16. The method as claimed in claim 13,
wherein
the document output unit determines a gray scale of a color corresponding to the feature index of each retrieval keyword with reference to a feature index/gray scale table in which a corresponding relation of the feature index to the gray scale of the color is registered, and the retrieval keyword is displayed using the determined gray scale of the color in a different manner from a manner in which other words are displayed.

17. The document retrieval apparatus as claimed in claim 1,
wherein
a type face corresponding to the feature index of each retrieval keyword is determined with reference to a feature index/type face table in which a corresponding relation of the feature index to the type face is registered, and the retrieval keyword is displayed using the determined type face in a different manner from a manner in which other words are displayed.

18. The method as claimed in claim 17,
wherein
the type face includes at least one of font, size, and style of a character.

19. The method as claimed in claim 13, further comprising the step of:
ranking the retrieval keywords included in the selected documents in accordance with a feature index indicating an extent to which each retrieval keyword has contributed to the selection of the selected documents.

20. A method of retrieving documents, comprising the steps of:
accepting an input of a query character string including a plurality of retrieval keywords;
selecting one or more documents that match the query character string from a document database;
presenting retrieval results of the selected documents to a user; and
presenting the contents of one of the selected documents designated by the user;
wherein
in the step of accepting an input of the query character string, an input of a word other than the retrieval keywords that is to be highlighted in the presented one of the selected documents can be designated.

21. The method as claimed in claim 20,
wherein
a retrieval keyword that is not to be highlighted in the designated one of the selected documents can be designated.

22. A method of retrieving documents, comprising the steps of:
accepting an input of a query character string including a plurality of retrieval keywords;
selecting one or more documents that match the query character string from a document database;
presenting retrieval results of the selected documents to a user; and
presenting the contents of one of the selected documents designated by the user;
wherein
a list of the retrieval keywords used for the retrieval is displayed; and
when one of the retrieval keywords in the list is selected, the presented one of the selected documents is scrolled up to a place where the selected one of the retrieval keywords is first included.

23. The method as claimed in claim 22,
wherein
when any one of the retrieval keywords included in the presented one of the selected documents is selected, the document is scrolled to a next place where the selected one of the retrieval keywords appears, and the next place is displayed.

24. The method as claimed in claim 22,
wherein
in the step of presenting one of the selected documents, position information that indicates a position of the selected one of the retrieval keywords in the presented one of the selected documents is displayed.

25. A computer program that causes a computer to operate as the document retrieval apparatus as claimed in claim 1.

26. A computer readable recording medium storing the computer program as claimed in claim 25.
